(19) United States
(12) Patent Application Publication
(10) Pub. No.: US 2021/0374110 A1
(43) Pub. Date: Dec. 2, 2021

(54) DETECTION SYSTEM AND METHOD, AND RELATED APPARATUS

(71) Applicant: CLOUDMINDS (SHENZHEN) HOLDINGS CO., LTD., Shenzhen, Guangdong (CN)

(72) Inventors: Lei LUO, Shenzhen, Guangdong (CN); Taotao MU, Shenzhen, Guangdong (CN); Wei YANG, Shenzhen, Guangdong (CN)

(73) Assignee: CLOUDMINDS (SHENZHEN) HOLDINGS CO., LTD., Shenzhen, Guangdong (CN)

(21) Appl. No.: 16/341,423

(22) PCT Filed: Dec. 20, 2017
(86) PCT No.: PCT/CN2017/117580

§ 371 Date: Apr. 11, 2019

(51) Int. Cl. G06F 16/21; G06F 16/245; G06F 16/23

(52) U.S. Cl. CPC G06F 16/211; G06F 16/2372; G06F 16/245

(57) ABSTRACT

Provided are a detection system and method, and related apparatuses. The detection system includes a cloud detection platform and a detection terminal, wherein a cloud public database and a first user self-built library corresponding to a user are deployed on the cloud detection platform. The detection terminal is configured to, after it is determined that the user successfully logs in and the logging is not for the first time, send a database access request carrying features of a to-be-detected substance to the cloud detection platform, and receive a detection result returned by the cloud detection platform. The cloud detection platform is configured to receive the database access request sent by the detection terminal, detect the features of the to-be-detected substance based on the cloud public database and the first user self-built library to obtain the detection result, and return the detection result to the detection terminal.

### CROSS-REFERENCE TO RELATED APPLICATIONS

This application claims the benefit of PCT application No. PCT/CN2017/117580 filed on Dec. 20, 2017, the contents of which are incorporated herein by reference.

### TECHNICAL FIELD

The present application relates to detection technical field, and in particular, to a detection system and method, and related apparatuses.

### BACKGROUND

The current professional detection devices are basically stand-alone devices. Usually, after detecting a substance, the detection device inputs a detection result into a database to query whether a substance matching the detection result exists in the database. Due to the limitation of the database, the detection device cannot detect all substances. Therefore, a user may give a name to an unidentified substance in a detection process and store the name in a local self-built library. As for the name, the user may know exactly what the substance is, such as potassium cyanide; or the user may not sure what the substance is, but adds a label to the substance to know that the same kind of substance is detected in the subsequent detection process, such as white powder X.

However, since the detection devices are generally expensive, a plurality of detection devices are generally shared by many people in actual detection scenarios. That is to say, in many cases, the user uses a detection device A at this time and establishes a local self-built library in the detection device A, but the user may be unable to use the detection device A next time, but may only select the detection device B, so that the user needs to re-establish the local self-built library in the detection device B, and the re-establishment method may be selected from one of the two following approaches: 1. finding samples which have been established the local self-built library on the detection device A, and repeating the adding operation, but the process is cumbersome, and the samples may not be found; and 2. finding the detection device A and copying the local self-built library from the detection device A to the detection device B, but the detection device A cannot be found immediately at most times.

Therefore, how to realize the use of the self-built libraries by the users across devices in the case of multi-person to multi-device is a problem that needs to be solved.

### SUMMARY

One technical problem to be solved by a part of embodiments of the present application is that users may use self-built libraries across devices in the case of multi-person to multi-device.

An embodiment of the present application provides a detection system, including a cloud detection platform and a detection terminal, wherein a cloud public database and a first user self-built library corresponding to a user are deployed on the cloud detection platform; the detection terminal is configured to, after it is determined that the user successfully logs in and the logging is not for the first time, send a database access request carrying features of a to-be-detected substance to the cloud detection platform, and receive a detection result returned by the cloud detection platform; and the cloud detection platform is configured to receive the database access request sent by the detection terminal, detect the features of the to-be-detected substance based on the cloud public database and the first user self-built library to obtain the detection result, and return the detection result to the detection terminal.

An embodiment of the present application further provides a detection method, applied to a detection terminal, including: determining that a user successfully logs in and the logging is not for the first time; sending a database access request carrying features of a to-be-detected substance to a cloud detection platform, wherein a cloud public database and a first user self-built library corresponding to the user are deployed on the cloud detection platform; and receiving a detection result returned by the cloud detection platform; wherein the cloud detection platform receives the database access request sent by the detection terminal, detects the features of the to-be-detected substance based on the cloud public database and the first user self-built library to obtain the detection result, and returns the detection result to the detection terminal.

An embodiment of the present application further provides a detection method, applied to a cloud detection platform, wherein a cloud public database and a first user self-built library corresponding to a user are deployed on the cloud detection platform, and the detection method includes: receiving a database access request carrying features of a to-be-detected substance sent by a detection terminal, wherein the database access request is sent by the detection terminal after determining that the user successfully logs in and the logging is not for the first time, and determining that a network connection is established with the cloud detection platform; detecting the features of the to-be-detected substance based on the cloud public database and the first user self-built library to obtain a detection result; and returning the detection result to the detection terminal.

An embodiment of the present application further provides a detection terminal, including: a determining module, configured to determine that a user successfully logs in and the logging is not for the first time; a sending module, configured to send a database access request carrying features of a to-be-detected substance to a cloud detection platform, wherein a cloud public database and a first user self-built library corresponding to the user are deployed on the cloud detection platform; and a receiving module, configured to receive a detection result returned by the cloud detection platform; wherein the cloud detection platform receives the database access request sent by the detection terminal, detects the features of the to-be-detected substance based on the cloud public database and the first user self-built library to obtain the detection result, and returns the detection result to the detection terminal.

An embodiment of the present application further provides a cloud detection platform, including: a receiving module, configured to receive a database access request carrying features of a to-be-detected substance sent by a detection terminal, wherein the database access request is sent by the detection terminal after determining that a user successfully logs in and the logging is not for the first time, and determining that a network connection is established with the cloud detection platform; a detecting module, configured to detect the features of the to-be-detected substance based on the cloud public database and the first user self-built library to obtain a detection result; and a sending module, configured to return the detection result to the detection terminal.

An embodiment of the present application further provides a detection terminal, including: at least one processor; and a memory and a communication component, which are in communication connection with the at least one processor, the communication component receiving and/or sending data under the control of the processor, wherein the memory stores instructions executable by the at least one processor, and the instructions are executed by the at least one processor to enable the at least one processor to execute the above detection method applied to the detection terminal.

An embodiment of the present application further provides a cloud service platform, including: at least one processor; and a memory and a communication component, which are in communication connection with the at least one processor, the communication component receiving and/or sending data under the control of the processor, wherein the memory stores instructions executable by the at least one processor, and the instructions are executed by the at least one processor to enable the at least one processor to execute the above detection method applied to the cloud detection platform.

An embodiment of the present application further provides a computer readable storage medium storing a computer program, and the computer program executes the above detection method applied to the detection terminal when being executed by a processor.

An embodiment of the present application further provides a computer readable storage medium storing a computer program, and the computer program executes the above detection method applied to the cloud detection platform when being executed by a processor.

Compared with the prior art, the embodiments of the present application have the advantages that the cloud public database and the first user self-built library are stored in the cloud detection platform, and different detection terminals can submit database access requests, so that the user can still access the cloud public database and the first user self-built library and perform detection after changing the detection terminal, and the user may not need to re-establish the self-built library on the changed detection terminal, therefore the user can use the self-built library across devices in the case of multi-person to multi-device.

### BRIEF DESCRIPTION OF THE DRAWINGS

One or more embodiments are exemplified by figures in corresponding drawings, these exemplary descriptions do not constitute limitations of the embodiments, elements having the same reference signs in the drawings are represented as similar elements, and unless otherwise stated, the figures in the drawings do not constitute proportional limits.

FIG. 1 is a structural schematic diagram of a detection system in a first embodiment of the present application;

FIG. 2 is a flowchart of a detection method in a third embodiment of the present application;

FIG. 3 is a flowchart of a downloading process of a local public database and a second user self-built library in the third embodiment of the present application;

FIG. 4 is a flowchart of a specific update process according to an offline self-built library in a fourth embodiment of the present application;

FIG. 5 is a flowchart of a specific update process according to the second user self-built library in the fourth embodiment of the present application;

FIG. 6 is a flowchart of a detection method in a fifth embodiment of the present application;

FIG. 7 is a flowchart of a specific provision process of a sixth embodiment of the present application;

FIG. 8 is a structural schematic diagram of a detection terminal in a seventh embodiment of the present application;

FIG. 9 is a structural schematic diagram of a detection terminal in an eighth embodiment of the present application;

FIG. 10 is a structural schematic diagram of a cloud detection platform in a ninth embodiment of the present application;

FIG. 11 is a structural schematic diagram of a detection terminal in an eleventh embodiment of the present application; and

FIG. 12 is a structural schematic diagram of a detection terminal in a twelfth embodiment of the present application.

### DETAILED DESCRIPTION OF THE EMBODIMENTS

In order that the objects, the technical solutions and the advantages of the present application are clearer, a part of embodiments of the present application will be further described in detail below in combination with the drawings and embodiments. It should be understood that the specific embodiments described herein are merely used for explaining the present application rather than limiting the present application.

A first embodiment of the present application relates to a detection system, as specifically shown in FIG. 1. The detection system includes a cloud detection platform 101 and a detection terminal 102. A cloud public database and a first user self-built library corresponding to a user are deployed on the cloud detection platform 101. After it is determined that the user successfully logs in and the logging is not for the first time, the detection terminal 102 may send a database access request carrying the features of a to-be-detected substance to the cloud detection platform 101, and may receive a detection result returned by the cloud detection platform 101. The cloud detection platform 101 may receive the database access request sent by the detection terminal 102, detect the features of the to-be-detected substance based on the cloud public database and the first user self-built library to obtain the detection result, and may return the detection result to the detection terminal 102.

It should be noted that the detection terminal 102 has a communication function.

In the implementation, a user login channel provided by the detection terminal 102 may perform login by using a username and a password and may also perform the login through a unique identification code such as a two-dimensional code. Those skilled in the art may understand that, in practical application, the login mode may be set according to needs.

It should be noted that the deployment manner of the cloud public database and the first user self-built library may be that a database is deployed by using software supporting a structured query language (Structured Query Language, SQL), and a database may also be deployed by using software supporting other programming languages. The specific implementation form of the database is not the focused content of the present application, and in practical application, the manner of establishing the database may be selected according to actual conditions.

In the implementation, the features of the to-be-detected substance may be compositions of the to-be-detected substance, but it does not mean that the features of the to-be-detected substance may only be the compositions of the to-be-detected substance, and in practical application, the specific expression form of the features of the to-be-detected substance may be determined according to needs.

The detection result returned by the cloud detection platform 101 may be the name of the to-be-detected substance, the use scope of the to-be-detected substance, matters needing attention and other contents, and may also be a code including the foregoing contents. In practical application, the expression form of the detection result may be set as needed, and the protection scope of the present application is not limited thereto.

In the implementation, after receiving the detection result returned by the cloud detection platform 101, the detection terminal 102 may perform a series of operations such as data analysis, code parsing and data display on the detection result as needed. Those skilled in the art may understand that, in practical application, subsequent steps of receiving the detection result may be set as needed.

In a specific implementation, a local public database and a second user self-built library corresponding to the user may also be deployed on the detection terminal 102. The cloud public database includes the local public database, and the first user self-built library and the second user self-built library corresponding to the same user are same. After the failure of sending the database access request, the detection terminal 102 detects the features of the to-be-detected substance based on the local public database and the second user self-built library deployed on the detection terminal 102 to obtain the detection result. Due to the deployment of the local public database and the second user self-built library, in the case that the network access request fails due to a poor network or other reasons, the detection terminal 102 may obtain the detection result based on the local public database and the second user self-built library, so that the detection system works effectively under various conditions, and the reliability of the detection system is improved.

It should be noted that, those skilled in the art may understand that, when the local public database is deployed, the permission of which may be set to be used after the login of the user and may also be set to be used without login, and the access permission of the local public database is not limited in the present embodiment.

It should be noted that those skilled in the art may understand that, in practical application, the local public database may be an authoritative database provided by a manufacturer of the detection device and the detection solution. The local public database may also be a database established by an owner of the detection terminal 102 according to the use scope of the detection device. The source of data stored in the local public database is not limited in the present embodiment.

It should be noted that, in practical application, the capacity of the local public database may be determined according to the computing processing capability of the detection terminal 102.

In a specific implementation, after the user successfully logs in for the first time and establishes a network connection with the cloud detection platform 101, the detection terminal 102 sends a downloading request to the cloud detection platform 101; after receiving the downloading request sent by the detection terminal, the cloud detection platform 101 selects a part of items from the cloud public database to return to the detection terminal 102 as the local public database, and/or, returns the first user self-built library to the detection terminal 102 as the second user self-built library; and the detection terminal 102 receives the local public database and/or the second user self-built library returned by the cloud detection platform 101 according to the downloading request.

The downloading request sent by the detection terminal 102 may only include a downloading instruction, and may also include the downloading instruction, a part of items to be downloaded selected by the user and other information. When the user logs in for the first time, the data of the cloud detection platform 101 are selectively downloaded to the local public database and/or the second user self-built library according to the needs of the user to provide possibility for the detection terminal 102 to obtain the detection result in the case of network failure.

Since the data are selectively downloaded, the data received by the detection terminal 102 better conform to the needed data of the user. It should be noted that, the cloud detection platform 101 may determine the downloaded partial items after analyzing the user registration information and may also directly determine the downloaded partial items according to the selection of the user. Those skilled in the art may understand that, in practical application, the manner of determining the partial items be set as needed.

In a specific implementation, the detection terminal 102 may obtain the user registration information as needed when determining that the user logs in for the first time.

In a specific implementation, the detection terminal 102 may also update the second user self-built library after determining that the user successfully logs in, and send first update information to the cloud detection platform 101 when establishing the network connection with the cloud detection platform 101, and the first update information carries the updated items in the second user self-built library; and the cloud detection platform 101 receives the first update information sent by the detection terminal 102, and updates the first user self-built library according to the updated items carried in the first update information. Due to this manner, the first user self-built library may be updated according to the modification of the second user self-built library by the user during the use.

It should be noted that, the first update information may be periodically sent in a user login process and may also be sent after a first update instruction input by the user is received. In practical application, the sending time of the first update information may be set as needed. After the second user self-built library is updated, the first user self-built library is updated in time to ensure the consistency of the first user self-built library and the second user self-built library.

In a specific implementation, after updating the second user self-built library and before sending the first update information to the cloud detection platform 101, if the detection terminal 102 detects a logout operation of the user, the detection terminal prompts the user that items that are not updated to the cloud detection platform 101 exist in the second user self-built library, so that update failure caused by the logout operation of the user may be avoided.

In a specific implementation, an offline self-built library bound with the detection terminal 102 is further deployed on the detection terminal 102. The detection terminal 102 updates the offline self-built library according to the user operation after determining that the user does not log in, and updates second user self-built library according to the update information of the offline self-built library after determining that the user successfully logs in, and sends second update information to the cloud detection platform 101 in the case of establishing the network connection with the cloud detection platform 101, and the second update information carries the updated items in the second user self-built library. Due to the implementation manner, the offline self-built library may be synchronously updated to the first user self-built library and the second user self-built library if the user does not log in.

Compared with the prior art, the detection system provided in the present embodiment has the advantages that, the cloud public database and the first user self-built library are stored in the cloud detection platform 101, different detection terminals 102 can submit database access requests, so that the user can still use the cloud public database and the first user self-built library and perform detection after changing the detection terminal 102, and the user does not need to re-establish the self-built library on the detection terminal after replacement, therefore the user can use the self-built library across devices in the case of multi-person to multi-device.

A second embodiment of the present application relates to a detection system, the present embodiment represents a further improvement on the basis of the first embodiment, and the specific improvement lies in that: in the second embodiment, the cloud public database includes a cloud official database and a first enterprise self-built library. The local public database includes a local official database and a second enterprise self-built library. The cloud official database includes the local official database, and the first enterprise self-built library is the same as the second enterprise self-built library. Since the local public database on the detection terminal 102 includes the second enterprise self-built library, the user may access the second enterprise self-built library in the absence of the network.

It should be noted that the cloud official database may include an authoritative database provided by the manufacturer of the detection device and the detection solution, and may also include some standards in the field to which the to-be-detected substance belongs. In practical application, the contents of the cloud official database may be set as needed. When the cloud official database is an authoritative cloud database provided by the manufacturer of the detection device and the detection solution, the management permission of the cloud official database may be handed over to the manufacturer, and the manufacturer is responsible for the update and maintenance. The cloud official database and the first enterprise self-built library are separately stored to protect the enterprise data security.

Specifically, the second enterprise self-built library is a public database of a plurality of detection terminals 102 of the same group, in the case that the network of the cloud detection platform 101 is unobstructed, the second enterprise self-built libraries of all detection terminals 102 in the group keep the synchronization with the first enterprise self-built library of the cloud detection platform 101. In practical application, the access and management permissions of the first enterprise self-built library and the second enterprise self-built library may be set as needed.

In a specific implementation, after determining that the user successfully logs in and the user is an authorized user of the first enterprise self-built library and the second enterprise self-built library, and in the case of establishing the network connection with the cloud detection platform 101, the detection terminal 102 updates the second enterprise self-built library according to the offline self-built library, and sends third update information to the cloud detection platform 101, and the third update information carries the updated items in the second enterprise self-built library. After receiving the third update information, the cloud detection platform 101 updates the first enterprise self-built library according to the third update information. Due to the manner, the authorized user may update the first enterprise self-built library and the second enterprise self-built library according to the offline self-built library, thereby ensuring the timely and effective update of the first enterprise self-built library and the second enterprise self-built library.

It should be noted that the cloud detection platform 101 may also send the third update information to other detection terminals 102 that belong to the same group as the detection terminal 102, and the other detection terminals 102 update the respective second enterprise self-built libraries according to the third update information, therefore the consistency of the second enterprise self-built libraries of the detection terminals of the same group may be ensured.

It is worth mentioning that the detection terminal 102 may synchronously update the second enterprise self-built libraries of the other detection terminals of the same group to realize real-time sharing in the group.

In a specific implementation, the detection terminal 102 obtains items selected by the user from the second user self-built library after detecting that the user successfully logs in and that the user is the authorized user of the first enterprise self-built library and the second enterprise self-built library, updates the second enterprise self-built library according to the selected items in the case of establishing the network connection with the cloud detection platform 101, and sends fourth update information to the cloud detection platform 101, and the fourth update information carries the updated items in the second enterprise self-built library. The cloud detection platform 101 receives the fourth update information and updates the first enterprise self-built library according to the fourth update information. Due to the manner, the authorized user may update the first enterprise self-built library and the second enterprise self-built library according to the second user self-built library to ensure the timely and effective update of the first enterprise self-built library and the second enterprise self-built library.

The detection terminal 101 may also set the items selected by the user from the second user self-built library as a hidden state or delete the items, so as to avoid the same items existing in the user self-built libraries (the first user self-built library and the second user self-built library) and the enterprise self-built libraries (the first enterprise self-built library and the second enterprise self-built library) to ensure the detection efficiency. Of course, the detection terminal 101 may also delete unnecessary items in the second user self-built library according to the setting of the user, thereby avoiding unnecessary information occupying the storage space, and may also hide the items in the second user self-built library according to the setting of the user.

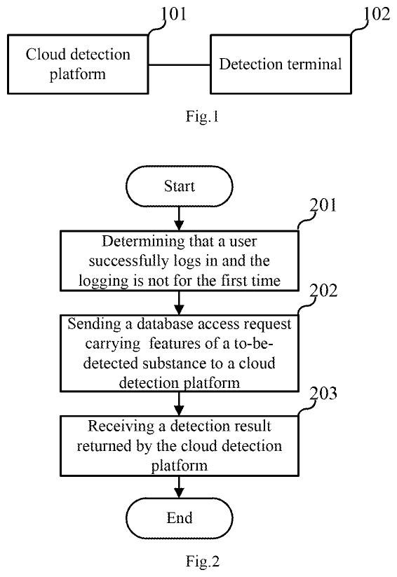

A third embodiment of the present application relates to a detection method, applied to a detection terminal, and the specific implementation of the detection method may be understood by referring to the related descriptions of the detection terminal in the first embodiment and the second embodiment. As shown in FIG. 2, the specific implementation process of the detection method is as follows:

Step 201: it is determined that a user successfully logs in and does not log in for the first time.

It should be noted that a user login channel provided by the detection terminal may perform login by using a username and a password and may also perform the login through a unique identification code such as a two-dimensional code, and in practical application, the login mode may be set according to needs.

Step 202: a database access request carrying features of a to-be-detected substance is sent to a cloud detection platform.

More Specifically, a cloud public database and a first user self-built library corresponding to the user are deployed on the cloud detection platform. The cloud detection platform receives the database access request sent by the detection terminal, detects the features of the to-be-detected substance based on the cloud public database and the first user self-built library to obtain a detection result, and returns the detection result to the detection terminal.

Step 203: the detection result returned by the cloud detection platform is received.

Compared with the prior art, the detection method provided by the present embodiment has the advantages that, the cloud public database and the first user self-built library corresponding to the user are stored on the cloud detection platform, therefore, the detection terminal may directly access the cloud public database and the first user self-built library corresponding to the user stored on the cloud detection platform through the network, in the case that the user logs in the detection terminal, and performs the detection, accordingly, the self-built library of the user is used across devices in the case of multi-person to multi-device.

In a specific implementation, a local public database and a second user self-built library corresponding to the user may also be deployed on the detection terminal. The cloud public database includes the local public database, and the first user self-built library and the second user self-built library corresponding to the same user are same. After the step 202 is executed, if the detection terminal determines that sending the database access request is failed, it does not execute the step 203, while detects the features of the to-be-detected substance based on the local public database and the second user self-built library to obtain the detection result. Due to the deployment of the local public database and the second user self-built library, in the case that the network access request fails due to a poor network or other reasons, the detection terminal 102 may obtain the detection result based on the local public database and the second user self-built library, so that the detection system works effectively under various conditions, and the reliability of the detection system is improved.

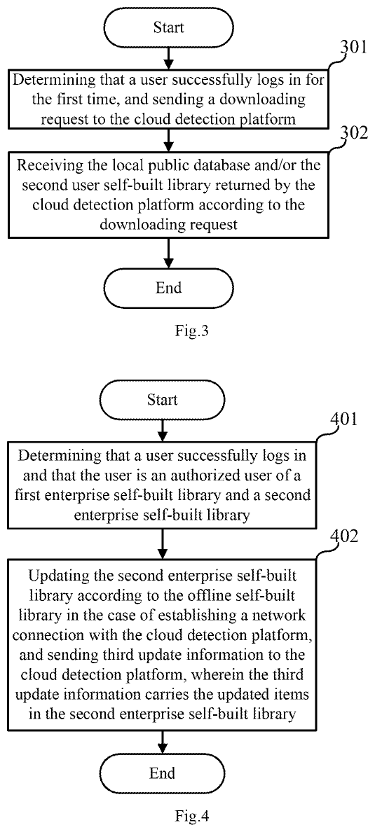

In a specific implementation, before the step 201 is executed, the local public database and the second user self-built library need to be downloaded from the cloud detection platform, so that the detection terminal may perform the detection based on the downloaded local public database and the second user self-built library in the case of network failure, and the specific downloading process is shown in FIG. 3:

Step 301: it is determines that the user successfully logs in for the first time, and a downloading request is sent to the cloud detection platform.

The cloud detection platform receives the downloading request sent by the detection terminal, and selects a part of items from the cloud public database to return to the detection terminal as the local public database, and/or, returns the first user self-built library to the detection terminal as the second user self-built library.

Step 302: the local public database and/or the second user self-built library returned by the cloud detection platform according to the downloading request is received.

In a specific implementation, the detection terminal may update the first user self-built library and the second user self-built library as needed after the user successfully logs in, the specific update process is as follows: updating the second user self-built library and sending first update information to the cloud detection platform, wherein the first update information carries updated items in the second user self-built library. The cloud detection platform receives the first update information sent by the detection terminal, and updates the first user self-built library according to the updated items carried in the first update information. Due to the manner, the user may update the first user self-built library according to the modification of the second user self-built library by the user in use.

After updating the second user self-built library and before sending the first update information to the cloud detection platform, if the detection terminal detects a user exit operation of the user, the detection terminal prompts the user that items that are not updated to the cloud detection platform exist in the second user self-built library, so that update failure caused by the logout operation of the user may be avoided.

In a specific implementation, an offline self-built library bound with the detection terminal is further deployed on the detection terminal. The detection terminal may perform detection according to the offline self-built library and may also update the offline self-built library in the case that the user does not log in, and may also update the second user self-built library and the first user self-built library by using the offline self-built library after the user successfully logs in, specifically: updating the second user self-built library according to the update information of the offline self-built library, and sending second update information to the cloud detection platform, wherein the second update information carries the updated items in the second user self-built library. The cloud detection platform receives the second update information and updates the first user self-built library according to the second update information. Due to the implementation manner, the offline self-built library may be synchronously updated to the first user self-built library and the second user self-built library if the user does not log in.

A fourth embodiment of the present application relates to a detection method, the present embodiment represents a further improvement on the basis of the third embodiment of the present application, and specific implementation of the detection method may be understood by referring to the related descriptions of the detection terminal in the first embodiment and the second embodiment. In the present embodiment, it is assumed that the cloud public database includes a cloud official database and a first enterprise self-built library, and the local public database includes a local official database and a second enterprise self-built library, wherein the cloud official database includes the local official database, and the first enterprise self-built library is the same as the second enterprise self-built library. Since the local public database on the detection terminal includes the second enterprise self-built library, the user may access the second enterprise self-built library in the absence of network.

In the present embodiment, the detection terminal may update the first enterprise self-built library and the second enterprise self-built library, and the specific update implementation manner includes, but is not limited to, the following two types:

In a first specific implementation, the update may be performed according to the offline self-built library bound with the detection terminal, and the specific process is as shown in FIG. 4:

Step 401: it is determined that the user successfully logs in and that the user is an authorized user of the first enterprise self-built library and the second enterprise self-built library.

Step 402: in the case of establishing a network connection with the cloud detection platform, the second enterprise self-built library is updated according to the offline self-built library, and third update information is sent to the cloud detection platform, wherein the third update information carries updated items in the second enterprise self-built library.

After receiving the third update information, the cloud detection platform updates the first enterprise self-built library according to the third update information.

In a second specific implementation, the update may be performed according to the second enterprise self-built library, and the specific process is as shown in FIG. 5:

Step 501: it is determined that the user is the authorized user of the first enterprise self-built library and the second enterprise self-built library.

Step 502: items selected by the user from the second user self-built library are obtained.

Step 503: the second enterprise self-built library is updated according to the selected items, and fourth update information is sent to the cloud detection platform, wherein the fourth update information carries the updated items in the second enterprise self-built library.

The cloud detection platform receives the fourth update information, and updates the first enterprise self-built library according to the fourth update information.

After updating the first enterprise self-built library and the second enterprise self-built library according to the second user self-built library, the detection terminal may set the items in the second user self-built library updated into the first enterprise self-built library and the second enterprise self-built library as a hidden state or delete the items, so as to avoid duplication and to ensure the detection efficiency.

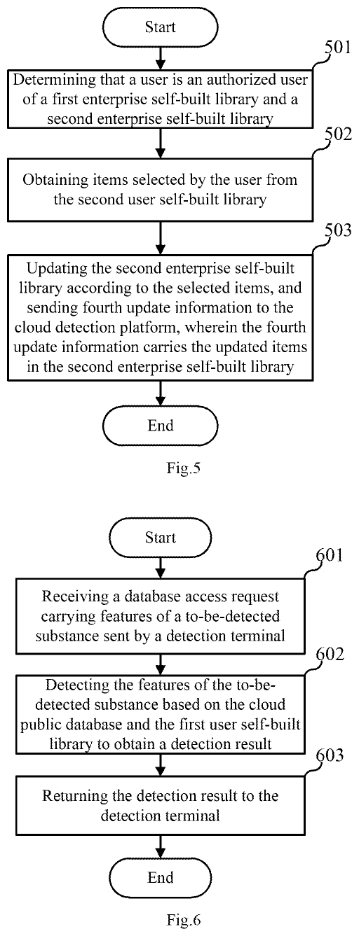

A fifth embodiment of the present application relates to a detection method, applied to a cloud detection platform, and the specific implementation of the method may be understood by referring to related descriptions of the cloud detection platform in the first embodiment and the second embodiment. As shown in FIG. 6, the detection method includes:

Step 601: a database access request with features of a to-be-detected substance sent by a detection terminal is received.

Specifically, a cloud public database and a first user self-built library corresponding to a user are deployed on the cloud detection platform.

Step 602: the features of the to-be-detected substance are detected based on the cloud public database and the first user self-built library to obtain a detection result.

Step 603: the detection result is returned to the detection terminal.

Specifically, since the detection terminal and the cloud detection platform establish a network connection, the cloud detection platform may send the detection result to the detection terminal.

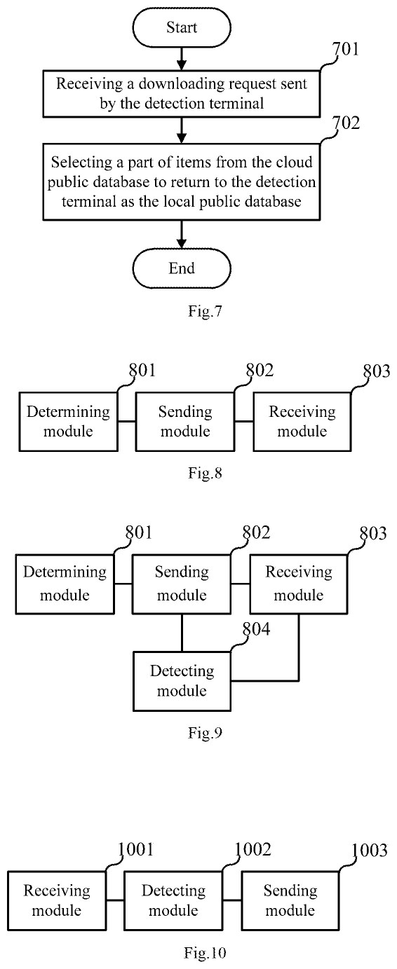

A sixth embodiment of the present application relates to a detection method, the present embodiment represents a further improvement on the basis of the fifth embodiment, and the specific implementation of the detection method may be understood by referring to related descriptions of the cloud detection platform in the first embodiment and the second embodiment. The specific improvement lies in that, when the user logs in the detection terminal for the first time, the data of the local public database and the second user self-built library are provided for the detection terminal according to the request of the detection terminal. The specific provision process is shown in FIG. 7:

Step 701: a downloading request sent by the detection terminal is received.

Specifically, after the user successfully logs in for the first time and after the network connection with the cloud detection platform is established, the detection terminal sends the downloading request to the cloud detection platform.

Step 702: a part of items is selected from the cloud public database to serve as a local public database to be returned to the detection terminal.

It should be noted that the items selected by the cloud detection platform may be determined according to the items selected by the user when logging in the detection terminal, and the items needing to be returned to the detection terminal may also be determined according to the permissions set when the cloud public database is created, and the manner of the cloud detection platform to select the partial items from the cloud public database is not limited in the present embodiment.

It should be noted that, in another embodiment, the step 702 may be replaced with: returning the first user self-built library to the detection terminal as the second user self-built library. The step 702 may also be replaced with: selecting a part of items from the cloud public database to return to the detection terminal as the local public database, and returning the first user self-built library to the detection terminal as the second user self-built library. The number and categories of the databases returned by the cloud detection platform after receiving the downloading request are not limited in the present embodiment.

The steps of the above various methods are divided for the sake of clarity of description, the steps may be merged into one step or some steps may be split during the implementation, the steps are decomposed into multiple steps, and as long as the same logical relationship is included, all variations are within the protection scope of the present application; and addition of insignificant modifications or introduction of insignificant designs to the algorithm or process without changing the core design of the algorithm and process is within the protection scope of the present application.

A seventh embodiment of the present application relates to a detection terminal, the specific implementation of the detection terminal may be understood by referring to the related descriptions of the detection terminal in the above embodiments, and the repeated descriptions are not described again, and as shown in FIG. 8, the detection terminal includes a determining module 801, a sending module 802, and a receiving module 803.

The determining module 801 is configured to determine that a user successfully logs in and the logging is not for the first time. The sending module 802 is configured to send a database access request carrying features of a to-be-detected substance to a cloud detection platform, wherein a cloud public database and a first user self-built library corresponding to the user are deployed on the cloud detection platform. The receiving module 803 is configured to receive a detection result returned by the cloud detection platform. The cloud detection platform receives the database access request sent by the detection terminal, detects the features of the to-be-detected substance based on the cloud public database and the first user self-built library to obtain the detection result, and returns the detection result to the detection terminal.

It should be noted that a local public database and a second user self-built library corresponding to the user are deployed on the detection terminal, the cloud public database includes the local public database, and the first user self-built library and the second user corresponding to the same user are same.

An eighth embodiment of the present application relates to a detection terminal, the present embodiment is substantially the same as the seventh embodiment, and the main difference is that, as shown in FIG. 9, the detection terminal of the present embodiment further includes a detecting module 804. The detecting module 804 is configured to detect the features of the to-be-detected substance based on the local public database and the second user self-built library deployed on the detection terminal to obtain the detection result, after the sending failure of the database access request.

A ninth embodiment of the present application relates to a cloud detection platform, the specific implementation of the cloud detection platform may be understood by referring to the related descriptions of the cloud detection platform in the above embodiments, and the repeated descriptions are not described again, and as shown in FIG. 10, the cloud detection platform includes a receiving module 1001, a detecting module 1002 and a sending module 1003.

The receiving module 1001 is configured to receive a database access request carrying features of a to-be-detected substance sent by a detection terminal. The database access request is sent by the detection terminal after determining that a user successfully logs in and the logging is not for the first time, and determining that a network connection is established with the cloud detection platform.

The detecting module 1002 is configured to detect the features of the to-be-detected substance based on the cloud public database and the first user self-built library to obtain a detection result.

The sending module 1003 is configured to return the detection result to the detection terminal.

It is worth mentioning that various modules involved in the seventh embodiment, the eighth embodiment and the ninth embodiment are logic modules, and in practical application, one logic unit may be a physical unit, may also be a part of a physical unit and may also be implemented as a combination of multiple physical units. In addition, in order to highlight the innovative parts of the present application, the present embodiment does not introduce a unit that is not closely related to solving the technical problem proposed by the present application, but this does not indicate that there are no other units in the present embodiment.

An eleventh embodiment of the present application relates to a detection terminal, as shown in FIG. 11, including at least one processor 1101; and a memory 1102 and a communication component 1103, which are in communication connection with the at least one processor 1101, and the communication component 1103 receives and/or sends data under the control of the processor 1101. The memory 1102 stores instructions executable by the at least one processor 1101, and the instructions are executed by the at least one processor 1101 to enable the at least one processor 1101 to execute the above detection method applied to the detection terminal.

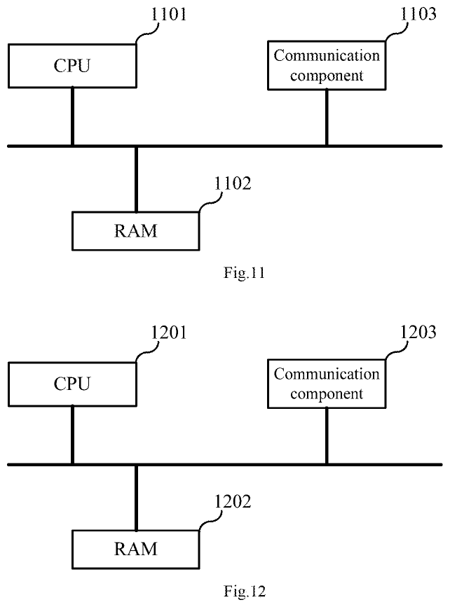

A twelfth embodiment of the present application relates to a cloud service platform, as shown in FIG. 12, including at least one processor 1201; and a memory 1202 and a communication component 11203, which are in communication connection with the at least one processor 1201, and the communication component 1203 receives and/or sends data under the control of the processor 1201. The memory 1202 stores instructions executable by the at least one processor 1201, and the instructions are executed by the at least one processor 1201 to enable the at least one processor 1201 to execute the above detection method in any one of the above embodiments.

In the eleventh embodiment and the twelfth embodiment, the processor is exemplified by a central processing unit (CPU), and the memory is exemplified by a random access memory (RAM). The processor and the memory may be connected by a bus or in other manners. The bus connection is taken as an example in FIG. 11 and FIG. 12. Serving as a nonvolatile computer readable storage medium, the memory may be used for storing a nonvolatile software program, a nonvolatile computer executable program and a module, for example, the cloud public database and the first user self-built in the embodiment of the present application are stored in the memory. The processor implements various function applications and data processing of the device, that is, implements the above detection method, by running the nonvolatile software programs, instructions and the module stored in the memory.

The memory may include a program storage area and a data storage area, wherein the program storage area may store an operating system, and an application required for at least one function; and the data storage area may store option lists, and the like. Further, the memory may include a high-speed random access memory and may also include a nonvolatile memory, such as at least one magnetic disk storage device, a flash memory or other nonvolatile solid state storage devices. In some embodiments, the memory optionally includes memories that are remotely located relative to the processor, and these remote memories may be connected to an external device through a network. Examples of the above network include, but not limited to, the Internet, an intranet, a local area network, a mobile communication network, and combinations thereof.

One or more modules are stored in the memory and execute the detection method in any one of the above method embodiments, when being executed by one or more processors.

The above-mentioned product may implement the method provided by the embodiment of the present application, and has corresponding functional modules and advantageous effects of executing the method, and technical details that are not described in detail in the present embodiment may be understood by referring to the method provided by the embodiment of the present application.

A thirteenth embodiment of the present application relates to a computer readable storage medium storing a computer program. The computer program may execute the detection method applied to the detection terminal or the detection method applied to the cloud detection platform described in any one of the above embodiments when being executed by a processor.

Those skilled in the art may understand that all or a part of the steps for implementing the method in the above embodiments may be completed by a program instructing related hardware, and the program is stored in a storage medium, including a plurality of instructions for causing a device (may be a single chip microcomputer, a chip or the like) or a processor to execute all or a part of steps of the method in various embodiments of the present application. The foregoing storage medium includes all kinds of media capable of storing program codes, such as a USB flash disk, a mobile hard disk, a read-only memory (ROM), a random access memory (RAM), a magnetic disk, or an optical disk, or the like.

Those of ordinary skill in the art may understand that, the above embodiments are specific embodiments for implementing the present application, but in practical application, various changes may be made in the forms and details without departing from the spirit and scope of the present application.

1. A detection system, comprising a cloud detection platform and a detection terminal, wherein a cloud public database and a first user self-built library corresponding to a user are deployed on the cloud detection platform;
the detection terminal is configured to, after it is determined that the user successfully logs in and the logging is not for the first time, send a database access request carrying features of a to-be-detected substance to the cloud detection platform, and receive a detection result returned by the cloud detection platform; and
the cloud detection platform is configured to receive the database access request sent by the detection terminal, detect the features of the to-be-detected substance based on the cloud public database and the first user self-built library to obtain the detection result, and return the detection result to the detection terminal.

2. The detection system according to claim 1, wherein a local public database and a second user self-built library corresponding to the user are deployed on the detection terminal, the cloud public database comprises the local public database, and the first user self-built library and the second user self-built library corresponding to the same user are same;
the detection terminal is further configured to, after the failure of sending the database access request, detect the features of the to-be-detected substance based on the local public database and the second user self-built library deployed on the detection terminal to obtain the detection result.

3. The detection system according to claim 2, wherein the cloud public database comprises a cloud official database and a first enterprise self-built library; and
the local public database comprises a local official database and a second enterprise self-built library, wherein the cloud official database comprises the local official database, and the first enterprise self-built library is the same as the second enterprise self-built library.

4. The detection system according to claim 3, wherein the detection terminal is further configured to:
after the user successfully logs in for the first time and establishes a network connection with the cloud detection platform, send a downloading request to the cloud detection platform, and receive the local public database and/or the second user self-built library returned by the cloud detection platform according to the downloading request; and
the cloud detection platform is further configured to:
receive the downloading request sent by the detection terminal, select a part of items from the cloud public database to return to the detection terminal as the local public database, and/or, return the first user self-built library to the detection terminal as the second user self-built library.

5. The detection system according to claim 3, wherein the detection terminal is further configured to:
update the second user self-built library after determining that the user successfully logs in, and send first update information to the cloud detection platform when establishing the network connection with the cloud detection platform, wherein the first update information carries the updated items in the second user self-built library; and
the cloud detection platform is further configured to:
receive the first update information sent by the detection terminal, and update the first user self-built library according to the updated items carried in the first update information.

6. The detection system according to claim 5, wherein the detection terminal is further configured to:
after updating the second user self-built library and before sending the first update information to the cloud detection platform, if a logout operation of the user is detected, prompt the user that items that are not updated to the cloud detection platform exist in the second user self-built library.

7. The detection system according to claim 3, wherein an offline self-built library bound with the detection terminal is further deployed on the detection terminal;
the detection terminal is further configured to:
update the offline self-built library according to the user operation after determining that the user does not log in; and update the second user self-built library according to the update information of the offline self-built library after determining that the user successfully logs in, and send second update information to the cloud detection platform in the case of establishing the network connection with the cloud detection platform, wherein the second update information carries the updated items in the second user self-built library; and
the cloud detection platform is further configured to:
receive the second update information, and update the first user self-built library according to the second update information.

8. The detection system according to claim 7, wherein the detection terminal is further configured to:
after determining that the user successfully logs in and the user is an authorized user of the first enterprise self-built library and the second enterprise self-built library, and in the case of establishing the network connection with the cloud detection platform, update the second enterprise self-built library according to the offline self-built library, and send third update information to the cloud detection platform, wherein the third update information carries the updated items in the second enterprise self-built library; and
the cloud detection platform is further configured to:
receive the third update information, and update the first enterprise self-built library according to the third update information.

9. The detection system according to claim 3, wherein the detection terminal is further configured to:
obtain items selected by the user from the second user self-built library after determining that the user successfully logs in and that the user is the authorized user of the first enterprise self-built library and the second enterprise self-built library, update the second enterprise self-built library according to the selected items in the case of establishing the network connection with the cloud detection platform, and send fourth update information to the cloud detection platform, wherein the fourth update information carries the updated items in the second enterprise self-built library; and
the cloud detection platform is further configured to:
receive the fourth update information, and update the first enterprise self-built library according to the fourth update information.

10. The detection system according to claim 9, wherein the detection terminal is further configured to:
set the items selected by the user from the second user self-built library as a hidden state or delete the items.

11. The detection system according to claim 8, wherein the cloud detection platform is further configured to:
send the third update information to other detection terminals that belong to the same group as the detection terminal, and the other detection terminals update the respective second enterprise self-built libraries according to the third update information.

12. A detection method, applied to a detection terminal, comprising:
determining that a user successfully logs in and the logging is not for the first time;
sending a database access request carrying features of a to-be-detected substance to a cloud detection platform, wherein a cloud public database and a first user self-built library corresponding to the user are deployed on the cloud detection platform; and
receiving a detection result returned by the cloud detection platform;
wherein the cloud detection platform receives the database access request sent by the detection terminal, detects the features of the to-be-detected substance based on the cloud public database and the first user self-built library to obtain a detection result, and returns the detection result to the detection terminal.

13. The detection method according to claim 12, wherein a local public database and a second user self-built library corresponding to the user are deployed on the detection terminal, the cloud public database comprises the local public database, and the first user self-built library and the second user self-built library corresponding to the same user are same;
after sending the database access request carrying features of the to-be-detected substance to the cloud detection platform, the detection method further comprises:
after the failure of sending the database access request, detecting the features of the to-be-detected substance based on the local public database and the second user self-built library deployed on the detection terminal to obtain the detection result.

14. The detection method according to claim 13, wherein the cloud public database comprises a cloud official database and a first enterprise self-built library; and
the local public database comprises a local official database and a second enterprise self-built library, wherein the cloud official database comprises the local official database, and the first enterprise self-built library is the same as the second enterprise self-built library.

15. The detection method according to claim 14, wherein before determining that the user successfully logs in and the logging is not for the first time, the detection method further comprises:
after the user successfully logs in for the first time, sending a downloading request to the cloud detection platform;
receiving the local public database and/or the second user self-built library returned by the cloud detection platform according to the downloading request; and
wherein the cloud detection platform receives the downloading request sent by the detection terminal, selects a part of items from the cloud public database to return to the detection terminal as the local public database, and/or, returns the first user self-built library to the detection terminal as the second user self-built library.

16. The detection method according to claim 14, wherein after determining that the user successfully logs in, the detection method further comprises:
updating the second user self-built library, and sending first update information to the cloud detection platform, wherein the first update information carries the updated items in the second user self-built library; and
wherein the cloud detection platform receives the first update information sent by the detection terminal, and updates the first user self-built library according to the updated items carried in the first update information.

17. The detection method according to claim 16, wherein after updating the second user self-built library, the detection method further comprises:
before sending the first update information to the cloud detection platform, if a logout operation of the user is detected, prompting the user that items that are not updated to the cloud detection platform exist in the second user self-built library.

18. The detection method according to claim 14, wherein an offline self-built library bound with the detection terminal is further deployed on the detection terminal;
before determining that the user successfully logs in, the detection method further comprises:
updating the offline self-built library according to the user operation after determining that the user does not log in;
after determining that the user successfully logs in, the detection method further comprises:
updating the second user self-built library according to the update information of the offline self-built library, and sending second update information to the cloud detection platform, wherein the second update information carries the updated items in the second user self-built library, and the cloud detection platform receives the second update information, and updates the first user self-built library according to the second update information.

19. The detection method according to claim 18, wherein after determining that the user successfully logs in, the detection method further comprises:
after determining that the user is an authorized user of the enterprise self-built libraries, updating the second enterprise self-built library according to the offline self-built library, and sending third update information to the cloud detection platform, wherein the third update information carries the updated items in the second enterprise self-built library; and wherein the cloud detection platform receives the third update information, and updates the first enterprise self-built library according to the third update information.

20. The detection method according to claim 14, wherein after determining that the user successfully logs in, the detection method further comprises:
obtaining items selected by the user from the second user self-built library after determining that the user is the authorized user of the first enterprise self-built library and the second enterprise self-built library, updating the second enterprise self-built library according to the selected items, and sending fourth update information to the cloud detection platform, wherein the fourth update information carries the updated items in the second enterprise self-built library; and
wherein the cloud detection platform receives the fourth update information, and updates the first enterprise self-built library according to the fourth update information.

21. The detection method according to claim 20, wherein after updating the second enterprise self-built library according to the selected items and sending the fourth update information to the cloud detection platform, the detection method further comprises:
setting the items selected by the user from the second user self-built library as a hidden state or deleting the items.

22. A detection method, applied to a cloud detection platform, wherein a cloud public database and a first user self-built library corresponding to a user are deployed on the cloud detection platform, and the detection method comprises:
receiving a database access request carrying features of a to-be-detected substance sent by a detection terminal, wherein the database access request is sent by the detection terminal after determining that the user successfully logs in and the logging is not for the first time, and determining that a network connection is established with the cloud detection platform;
detecting the features of the to-be-detected substance based on the cloud public database and the first user self-built library to obtain a detection result; and
returning the detection result to the detection terminal.

23. The detection method according to claim 22, wherein
a local public database and a second user self-built library corresponding to the user are deployed on the detection terminal, the cloud public database comprises the local public database, and the first user self-built library and the second user self-built library corresponding to the same user are same;
the cloud public database comprises a cloud official database and a first enterprise self-built library; and
the local public database comprises a local official database and a second enterprise self-built library, wherein the cloud official database comprises the local official database, and the first enterprise self-built library is the same as the second enterprise self-built library.

24. The detection method according to claim 23, wherein before receiving the database access request carrying the features of the to-be-detected substance sent by the detection terminal, the detection method further comprises:
receiving a downloading request sent by the detection terminal, selecting a part of items from the cloud public database to return to the detection terminal as the local public database, and/or, returning the first user self-built library to the detection terminal as the second user self-built library, wherein the downloading request is sent by the detection terminal after the user successfully logs in for the first time and establishing the network connection with the cloud detection platform.

25. A detection terminal, comprising:
at least one processor; and
a memory and a communication component, which are in communication connection with the at least one processor, and the communication component receiving and/or sending data under the control of the processor, wherein the memory stores instructions executable by the at least one processor, and the instructions are executed by the at least one processor to enable the at least one processor to execute the detection method according to claim 12.

26. A cloud service platform, comprising: at least one processor; and
a memory and a communication component, which are in communication connection with the at least one processor, the communication component receiving and/or sending data under the control of the processor, wherein the memory stores instructions executable by the at least one processor, and the instructions are executed by the at least one processor to enable the at least one processor to execute the detection method according to claim 22.

27. A computer readable storage medium storing a computer program, wherein the computer program executes the detection method according to claim 12 when being executed by a processor.

28. A computer readable storage medium storing a computer program, wherein the computer program executes the detection method according to claim 22 when being executed by a processor.
